(19) United States
(12) Patent Application Publication
(10) Pub. No.: US 2023/0258964 A1
(43) Pub. Date: Aug. 17, 2023

(54) APPARATUS AND METHOD FOR CONTROLLING A CHARACTERISTIC OF AN OPTICAL MODE

(71) Applicant: The University of Bristol, Bristol (GB)

(72) Inventors: Jorge Barreto, Bristol (GB); Gerardo Villarreal Garcia, San Nicolas De Los Garza (MX); Benjamin Burridge, Bristol (GB); Antonio Gentile, Magliano (IT)

(21) Appl. No.: 18/011,676

(22) PCT Filed: Jun. 23, 2021
(86) PCT No.: PCT/GB2021/051594

§ 371 Date: Dec. 20, 2022

(30) Foreign Application Priority Data
Jun. 23, 2020 (GB) 2009590.7

(51) Int. Cl. G02F 1/01

(52) U.S. Cl. CPC G02F 1/0147; G02F 1/011; G02F 2201/06

(57) ABSTRACT

There is presented an apparatus for controlling an optical mode propagating within an optical waveguide assembly. The optical waveguide assembly comprising at least a waveguide core material for guiding the optical mode and being in an environment comprising a substance. The apparatus comprises a processor configured to transmit one or more control signals to at least one energy emitter to reversibly change at least a portion of the substance in contact with a portion of the waveguide assembly in a localised area of the waveguide assembly, from a first state of matter to a second different state of matter. The change of state of matter changing a characteristic of the optical mode. The processor further receives a sensor signal from a sensor monitoring the optical mode. Also presented are methods associated with the apparatus and methods for controlling a characteristic of an optical mode.

The field of the present invention is controlling optical modes of waveguide assemblies in particular, but not limited to, changing the effective refractive index of guided modes.

The precision to which photonic integrated circuits (PICs), with integrated optic waveguides are manufactured may play a pivotal role in their performance. The manufacturing process is frequently refined, but a constant and re-occurring problem is that circuits often have to be optimised post-manufacture to behave as they were designed. Devices such as directional couplers, ring resonators, and multi-mode interferometers (MMIs) are sensitive to tolerances and errors in fabrication.

There are known methods of tuning PICs that make use of either the thermo-optic, or plasma-dispersion effect. Thermo-optic phase shifters (TOPS) modulate the refractive index of a material by changing its temperature, resulting in an index change proportional to the value of its thermo-optic coefficient. Close-proximity waveguide circuitry to the TOPS usually suffers from crosstalk, and the inherently thermal nature of the device leads to slow modulation speeds compared to those required for applications such as quantum information processing. Plasma-dispersion modulators (PDMs) can operate much faster as the devices rely on free-carrier manipulation, but this comes at the cost of higher optical losses due to free carrier absorption.

Practical applications of PICS include sensors, optical networks and quantum information processing. These applications may require PICs featuring a plethora of components. Integration of these components is desirable to enable scalability. The ability to tune the properties of an optical mode is desirable in PICs. Other types of optical waveguides such as optical fibres are frequently used in optical systems such as communication systems, optical sensors and optical testing apparatus. It is also desirable to have the ability to tune such waveguides.

JPH09159943 describes a waveguide type optical switch and its production wherein a magnetic force acts on a ferromagnetic material thin film, and a membrane is attracted to an electromagnet side, by which the volume of a housing pipe is increased. The liquid surface of a refractive index matching liquid falls. This refractive index matching liquid is discharged from a slit to the housing pipe and the end face of a core is exposed. The incident light on the branch path of an optical waveguide is reflected by the wall surface of the slit by a difference in the refractive index in an intersecting part, by which the light is bent to an orthogonal branch path.

US10509244B1 describes structures for an optical switch, structures for an optical router, and methods of fabricating a structure for an optical switch. A phase change layer is arranged proximate to a waveguide core, and a heater is formed proximate to the phase change layer. The phase change layer is composed of a phase change material having a first state with a first refractive index at a first temperature and a second state with a second refractive index at a second temperature. The heater is configured to selectively transfer heat to the phase change layer for transitioning between the first state and the second state.

In a first aspect of the present application there is provided a method for controlling a characteristic of an optical mode supported by a waveguide core material of a waveguide assembly; the method comprising: providing a substance in a first state of matter and in proximity to at least one control area of the waveguide assembly proximal to the waveguide core material; controlling at least one energy emitter to reversibly change between first and second emitter states; the first emitter state for changing the state of matter of a portion, or the totality, of the substance, in proximity of the at least one control area, from the first state of matter to a second state of matter that is different to the first state of matter, wherein the second state of matter of the substance in proximity to the at least one control area is associated with a first characteristic state of the optical mode; the second emitter state for changing the state of matter of a portion, or the totality, of the substance, in proximity of the at least one control area, from the second state of matter to the first state of matter; the first state of matter of the substance in proximity to the at least one control area associated with a second characteristic state of the optical mode that is different to the first characteristic state.

The first aspect may be modified according to any teaching herein, including, but not limited to any one or more of the following.

The method may further provide that the waveguide assembly comprises a plurality of control areas: wherein the characteristics of the optical mode supported by the portion of the core material proximal the control areas are controlled independently.

The method may further provide in any order: a) adding and/or removing material from the waveguide assembly to create one or more control areas of the waveguide assembly; b) providing a substance in a first state of matter and in proximity of at least one of the control areas.

The method may further comprise removing material of the waveguide assembly to form a structure within or proximal to the control area.

The method may further comprise removing waveguide cladding material to create a recess in a waveguide cladding layer.

The method may further comprise adding and/or removing material respectively to/from the waveguide assembly, the added and/or removed material forming at least a portion of any one or more of: i) the energy emitter; ii) a structure for delivering energy from the energy emitter to the control area.

The method may further comprise adding an element to the waveguide assembly, the element for heating the substance.

The method may be configured such that the waveguide assembly is within a temperature-controlled and/or pressure-controlled environment.

The method may be configured such that the waveguide assembly is within a cryogenic environment.

The method may be configured such that the substance is any of: i) substantial non-chemically reactive; and optionally, ii) comprises a noble gas, for example xenon.

The method may further comprise sending a control signal to the energy emitter to change its state from the first to the second emitter state or vice versa.

The method may provide that the core material forms at least part of any one or more of: an optical detector; an optical source; an optical waveguide circuit comprising a plurality of optical waveguides.

The method may provide that the first state of matter is a solid or a liquid.

The method may provide that the second state of matter is a gas.

In a second aspect there is presented an apparatus for controlling an optical mode propagating within an optical waveguide assembly; the optical waveguide assembly comprising at least a waveguide core material for guiding the optical mode and being in an environment comprising a substance; the apparatus comprising at least one energy emitter to reversibly change at least a portion of the substance in contact with a portion of the waveguide assembly in a localised area of the waveguide assembly, from a first state of matter to a second different state of matter; the change of state of matter changing a characteristic of the optical mode.

The second aspect may be modified according to any teaching herein, including, but not limited to any one or more of the following.

The apparatus may further comprise a sensor for monitoring the optical mode.

The apparatus may be configured such that at least one of the energy emitters comprises a heater.

The apparatus may be configured such that the heater is integral to the waveguide assembly.

The apparatus may be configured such that at least one of the energy emitters comprises a light source.

The apparatus may be configured such that the waveguide assembly is located within a temperature and/or pressure-controlled environment.

There is also presented a cryogenic system comprising the apparatus of the second aspect and comprising a chamber for accommodating the waveguide assembly.

The cryogenic system may be configured such that the substance comprises a noble gas, such as xenon.

The apparatus or cryogenic system may comprise an electronic processor for sending a control signal to the energy emitter to reversibly change the emitter between: a first emitter state for changing the state of matter of the substance from the first state of matter to a second state of matter; a second emitter state for changing the state of matter of the substance from the second state of matter to the first state of matter.

There is also presented a waveguide assembly comprising an apparatus of the second aspect.

In a third aspect there is presented an apparatus for controlling an optical mode propagating within an optical waveguide assembly; the optical waveguide assembly comprising at least a waveguide core material for guiding the optical mode and being in an environment comprising a substance, the apparatus comprising a processor configured to: I) transmit one or more control signals to at least one energy emitter to reversibly change at least a portion of the substance in contact with a portion of the waveguide assembly in a localised area of the waveguide assembly, from a first state of matter to a second different state of matter; the change of state of matter changing a characteristic of the optical mode; II) receive a sensor signal from a sensor monitoring the optical mode.

The third aspect may be modified according to any teaching herein, including, but not limited to any one or more of the following.

The apparatus may be configured such that the processor: generates one or more further control signals based upon the received sensor signal; transmits the one or more further control signal to the said at least one energy emitter.

The apparatus may be configured such that the generation of the further signal comprises comparing the sensor value to a reference value.

The apparatus may be configured such that transmitting one or more control signals comprises: transmitting a first control signal to a first energy emitter; transmitting a second control signal to a second energy emitter.

The apparatus may be configured such that the: first energy emitter is for reversibly changing at least a portion of the substance in contact with a portion of the waveguide assembly in a first localised area of the waveguide assembly; second energy emitter is for reversibly changing at least a portion of the substance in contact with a portion of the waveguide assembly in a second localised area of the waveguide assembly.

The apparatus may be configured such that the processor: generates a plurality of further control signals based upon the received sensor signal; transmits a first of the control signals to the first energy emitter.

The apparatus may further comprise any one or more of: the sensor; an optical source for generating light for inputting into the waveguide assembly; any of the energy emitters; a cryogenic chamber for accommodating the waveguide assembly.

The apparatus may be configured such that at least one of the energy emitters comprises a light source.

Examples will now be described in detail with reference to the accompanying drawings in which:

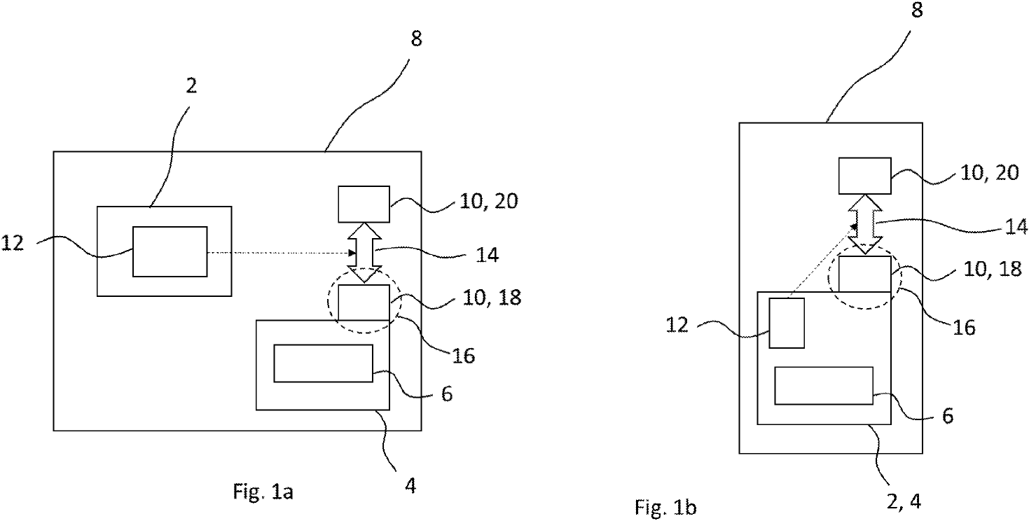

FIG. 1a is a schematic example of an apparatus for use with an optical waveguide assembly;

FIG. 1b is another schematic example of an apparatus for use with an optical waveguide assembly;

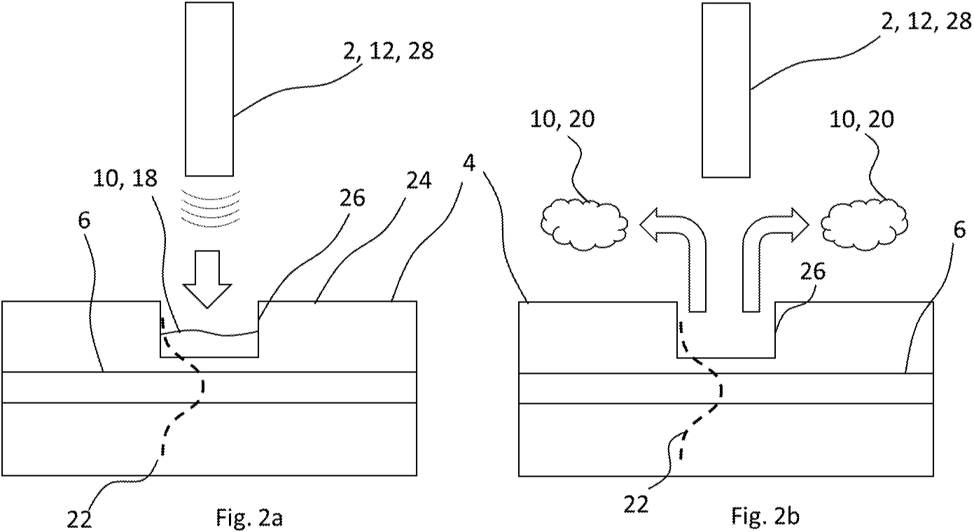

FIG. 2a is shows example of an apparatus for use with an optical waveguide assembly where a substance is in a first state of matter;

FIG. 2b is shows the example of FIG. 2a where the substance is in a second state of matter;

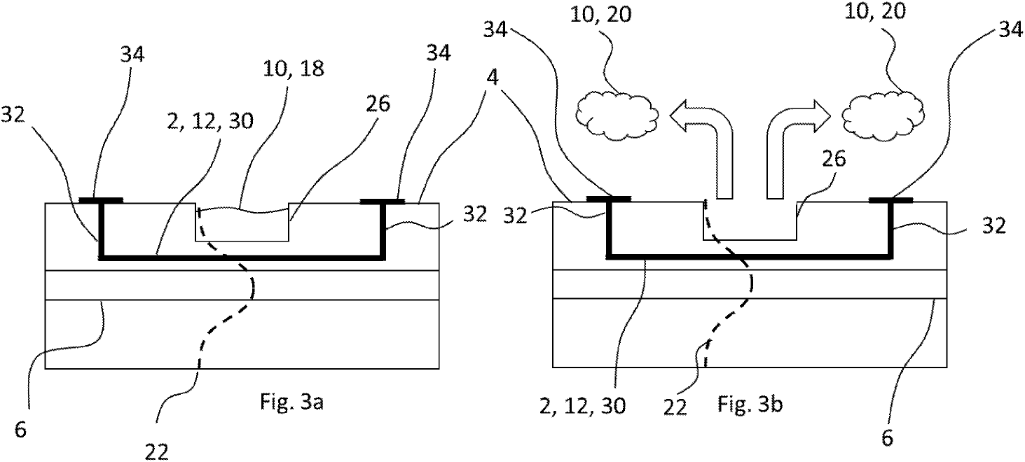

FIG. 3a is shows another example of an apparatus for use with an optical waveguide assembly where a substance is in a first state of matter;

FIG. 3b is shows the example of FIG. 3a where the substance is in a second state of matter;

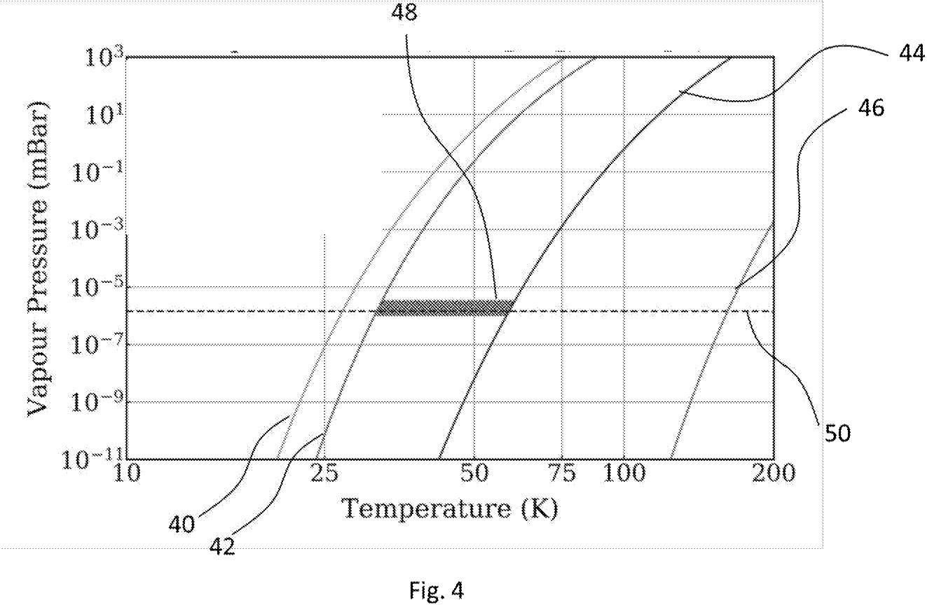

FIG. 4 shows a graph showing an example of relationships between vapour pressure and temperature of different substances with respect to sublimation;

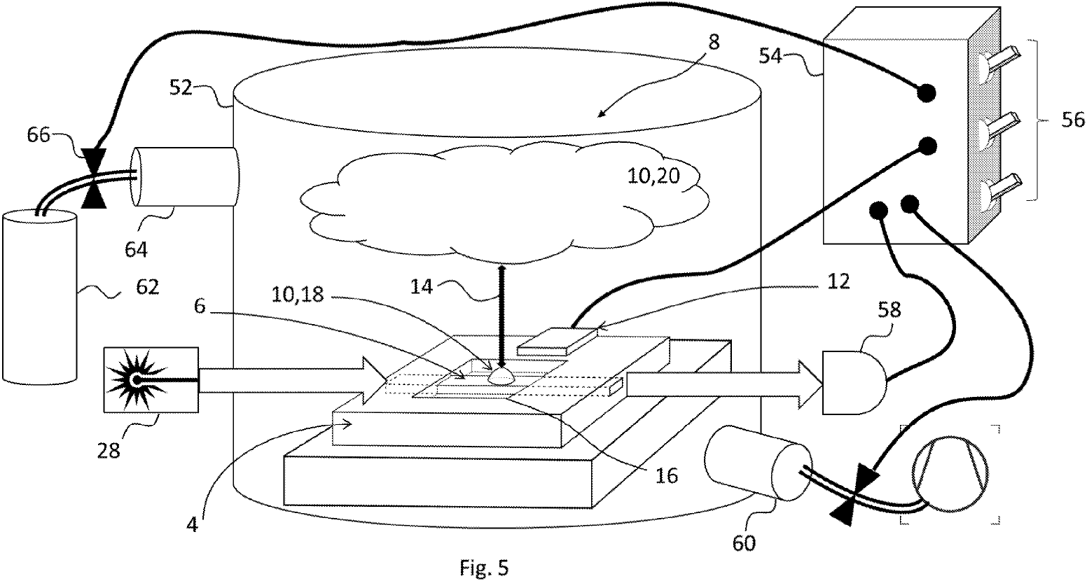

FIG. 5 shows an example of an apparatus using a cryogenic chamber;

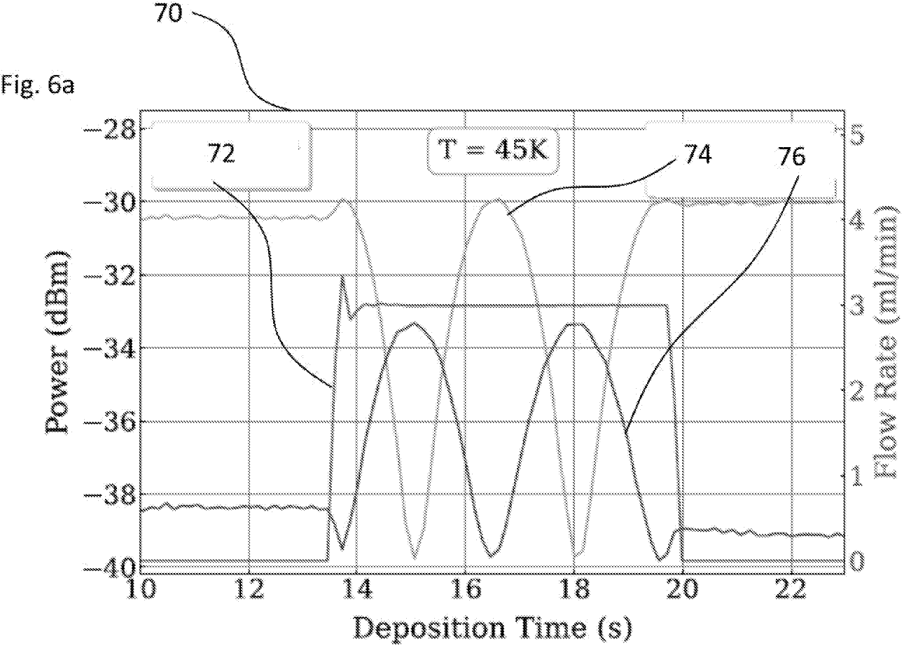

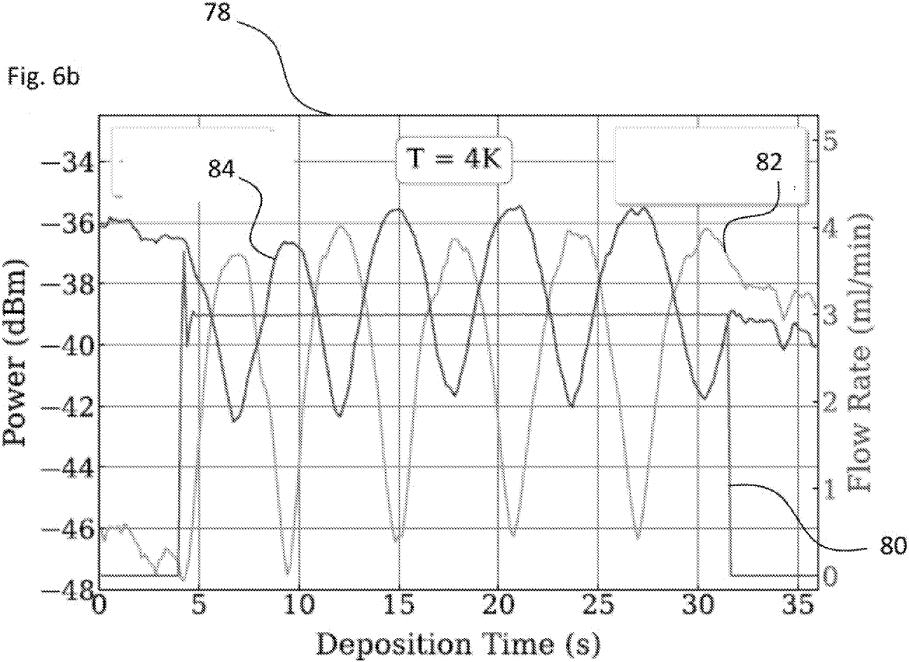

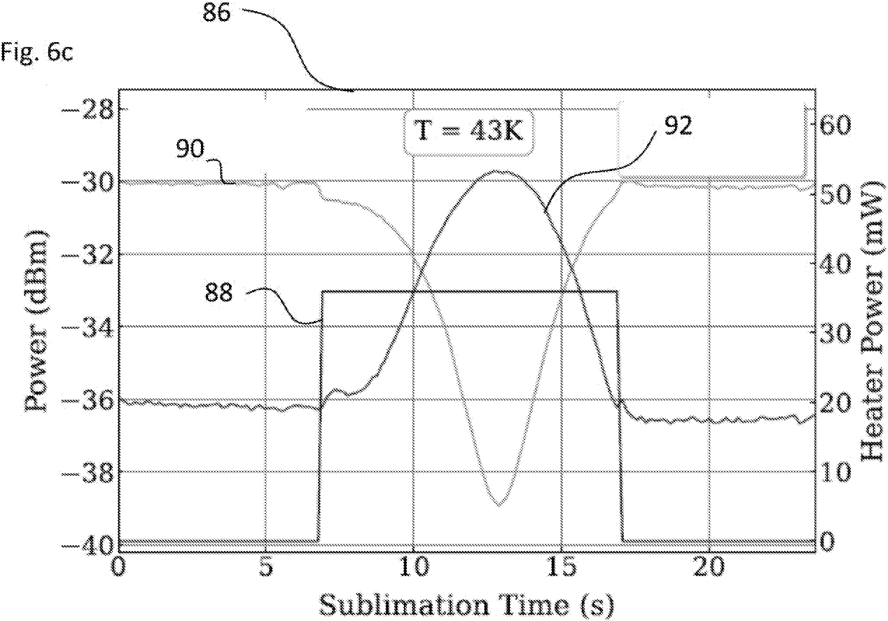

FIGS. 6a-6c show graphs indicating the change in the output of an integrated Mach Zehnder Interferometer (MZI) with Xe deposition and sublimation.

There is presented an apparatus 2 for use with an optical waveguide assembly 4. Schematic examples of the apparatus are shown in FIGS. 1a and 1b. The apparatus and its method of use are at least associated with the first and second aspects described above.

The optical waveguide assembly comprises at least a waveguide core material 6 and is in an environment 8 comprising a substance 10. The apparatus 2 comprises at least one energy emitter 12 to reversibly change 14 the state of matter of at least a portion of the substance 10 in contact with a portion of the waveguide assembly 4 in a localised area 16 of the waveguide assembly 4. The state of matter change going from a first state of matter 18 to a second different state of matter 20 (or vice versa).

FIG. 1a shows an example where the apparatus 2 is separate to the waveguide assembly 4 whilst FIG. 1b shows an example where at least a portion of the apparatus 2 forms part of the waveguide assembly 4.

Having a substance 10 that can controllably be changed from at least a first state of matter 18 to a second state of matter 20 and back again allows for control of properties of the waveguide assembly 4 (at least including the core material 6) that in turn affect the properties of one or many optical modes guided at least partially by the core material 6 and propagating in the waveguide assembly 4. This control may provide for applications such as, any of, optical switching, resonant cavity tuning, tuning of coupling, wavelength tuning of optical components such as optical detectors, optical fibres, optical sources such as lasers and LEDs, optical modulators, optical amplifiers, optical regenerators, passive optical components such as MMI’s, star couplers, directional couplers, Y-branches, Arrayed Waveguide Gratings (AWG’s) and other optical or integrated optic components or devices.

Because the substance 10 may not form part of the fabrication of the initial waveguide assembly, it may enable the above effects (switching etc) to be implemented on existing devices that do not nominally have the inherent ability to control the same properties or to the same extent as when the energy emitter 12 of the apparatus 2 is used to control the substance 10.

The substance 10 will typically not be part of the waveguide assembly 4 before it is placed into the environment 8. When both the substance 10 and the waveguide assembly 4 are introduced into the environment 8 the substance 10 may be in contact with the waveguide assembly 4.

The optical mode properties may depend on the effective refractive index, hence group velocity of one or more optical modes guided by the waveguide assembly 4.

The waveguide assembly properties that are changed may be the type of material and amount of material acting as a cladding to the core material 6. The aforesaid ‘amount of material’ typically manifests in a width, length or depth of this extra cladding material. Take, for example, the substance 10 in the first state of matter is a liquid or solid and in the second state of matter it is a gas. It is noted that not all the substance 10 in the vicinity of the localised area 16 may be required to change, just at least a portion of it. When a fraction of the substance 10 may be in one phase, and another fraction may be in another phase, the desired affect could still take place. Whilst the substance 10 is in the first state of matter and contacting the waveguide assembly 4, its presence as a cladding material about (but not necessarily contacting) the core may affect the effective refractive index of the optical mode carried by the core material 6. However, when the energy emitter 12 is used to change the substance 10 into a gas, the liquid / solid form will not be present anymore in the same area about the waveguide assembly 4 (or at least not to the same extent) and the effective index of the same mode will change. When the energy emitter 12 is turned off then the substance 10 may be allowed to reform onto the local area 16 again and change the effective index back.

### Laser Example

FIGS. 2a and 2b are now described to show an example of an apparatus 2 similar to the schematic shown in FIG. 1a.

In FIG. 2a the waveguide assembly 4 has a waveguide core material 6 formed as a straight integrated optic waveguide. The view of FIGS. 2a and 2b are shown taken through a cross section of the waveguide assembly 4 that passes through and along the straight length of the core waveguide 6. The waveguide cross section that the optical mode 22 experiences as it propagates along the waveguide 6 is therefore perpendicular to the cross section shown in FIGS. 2a and 2b. For purposes of this discussion the waveguide core 6 is a buried rectangular waveguide surrounded on all sides by cladding material of the waveguide assembly 4, however other waveguide geometries and types may be used including, rib or ridge waveguides, optical fibres or core waveguides 6 in free space that are supported at opposing ends by cladding materials.

A portion of the waveguide assembly cladding material is formed as a layer with a first surface contacting the core waveguide 6. This cladding material has a second (top) surface 24 disposed opposite the first surface. A recess 26 has been formed in the second surface 24. The recess 26 in this example extends inwardly into the cladding material from the top surface 24 towards the core material 6. At the bottom of the recess 26 is a bottom surface at an opposing end of the recess 26 to the recess opening in the top surface 24 of the cladding material. This bottom surface may be part of the cladding material, however the recess 26 may be formed to expose a portion of the core 6.

The optical mode 22 travelling through the core material has evanescent portions of its cross-sectional modal profile that extend outwardly from the core material 6 into the adjacent cladding regions. The recess 26 in this example is shown to be formed to a depth such that a significant portion of the optical mode, in particular, the evanescent tail, passes through the recess 26. The presence of the substance 10 in the first state (e.g. solid or liquid) within the recess presents a different refractive index in the recess 26 than when the same substance 10 is in the second state of matter of a gas. FIG. 2a shows the circumstance where the substance 10 is in a liquid state 18 and FIG. 2b shows the substance 10 having been evaporated into the second gaseous state 20. When in the second gaseous state 20, the substance 10 may still occupy at least a portion of the recess 26 or may be fully evacuated therefrom. In either situation, the refractive index of the (gaseous) substance 10 inside the recess 26 has a different refractive index to that of the substance 10 in the first liquid state 18. The optical mode 22 therefore experiences a different effective index, hence different group velocity and phase as it propagates through the region of the recess 26. The change in the effective refractive index may be used for the applications mentioned elsewhere herein.

In FIGS. 2a and 2b, the energy emitter 12 that is used to change the state of the substance 10 is a laser 28, however other electromagnetic wave sources may be used. The laser 28 in this example is directly above the recess 26 however any orientation or position may be used. The laser 28 is controlled by one or more electrical or optical signals sent to activate the laser 28. The signals may be transmitted by a control apparatus (not shown) having a transmitter and in communication with the laser 28 using any suitable means including wired or wireless communication methods. The control apparatus may be electronic apparatus and may further comprise an electronic processor for controlling the output of the signals. This control may come from an electronic memory that comprises instructions that when executed causes the processor to output (and/or stop the output) of the signals to the energy emitter 12. The laser 28 may output pulses or may be turned to a continuous wave (CW) operation to change the phase of the substance 10.

In this example, the waveguide assembly 4 and the apparatus 2 are located within a cryogenic environment, such as within the chamber of a cryostat, however other environments and apparatus hosting the environment may be used. The substance 10 in this example is Xenon, however other substances may be used.

Any one or more of the communication lines for controlling the energy emitter 12, the control apparatus, the processor, the memory the cryostat (or other environment hosting equipment) may form part of the apparatus 2.

### Heating Element Example

FIGS. 3a and 3b show a further example of an apparatus 2 that has some similarities to FIGS. 2a and 2b wherein like numerals represent like features. Unlike FIGS. 2a and 2b, the apparatus 2 in FIGS. 3a and 3b forms at least part of the waveguide assembly 4. Instead of a laser 28, the energy emitter 12 is a heating element 30 formed upon or within the waveguide assembly 4. The heating element 30, in this example, is formed within the cladding material, overlays (but does not contact) the core material 6 and is spaced from the core material 6 and the bottom of the recess 26 by sub layers of the cladding material such that the heating element 30 is surrounded on all sides by the cladding material of the waveguide assembly 4.

Generally, the heating element 30 is preferably thermally connected to the substance 10. This is typically based on heat conduction, although it could also be based on radiation, laser, or even induction.

Other configurations of the heating element 30 may also be possible including any one or more of: not being disposed directly over the core, having a portion of the heating element exposed to the substance; having a portion of the heating element exposed to the recess; being formed upon a surface of the cladding material; being formed around the recesses; directly contacting the core material 6. The heating element 30 may also be formed in a separate fabrication process after the fabrication of the waveguide assembly 4. For example, the heating element may be formed in the same fabrication processing as the creation of the recess 26.

The heating element 30 comprises one or more materials, preferably metals, for carrying electrical current and heating the local surrounding materials upon current being applied. The heating element has first and second opposing ends that electrically connect and physically connect to metal pillars 32 that extend from the ends to the top surface of the cladding where they terminate in metal contact electrodes 34. In use, one or more probes (not shown), that may form part of the apparatus 2, contact each of the two contact electrodes 34. The probes are electrically connected to a control apparatus similar to that described for FIGS. 2a/2b wherein the control apparatus drives current through the heating element 30. When the heating element heats up, a portion of the radiated heat is incident upon the recess 26 and causes the substance 10 to evaporate. The evaporation of the substance 10 causes a similar change in the effective index of the mode 22 as described for FIGS. 2a and 2b. A single heating element 30 is shown in FIGS. 3a and 3b however multiple heating elements 30 may be used. Other configurations of heating element 30 and associated electrical contacts may be used, for example a heating element 30 without needing pillars and/or being in the same plane as the contact electrodes.

The apparatus 2 of FIGS. 2a/b and 3a/b may be used separately or together and features and configurations of either example may be used in addition or in replacement to features of the other example. For example, an apparatus 2 may have any of: a plurality of heating elements, a plurality of lasers, or both. A further example of an apparatus 2 is described below with respect to FIG. 5 wherein any of the optional features and configurations described for FIGS. 2a, 2b, 3a, 3b may be used in the example of FIG. 5. Furthermore, any of the features described for FIG. 5, may be used in the above examples of FIGS. 2a/b and 3a/b. Furthermore, any of the examples of FIGS. 2a/b and 3a/b may be adapted according to any suitable feature or configuration described herein including but not limited to any of the following underneath.

### Optional Features and Configurations

The waveguide assembly 4 may be formed of any material or material system. The material forming the waveguide core 6 and/or cladding may be semiconductor or dielectric. The waveguide assembly 4 may comprise a hollow waveguide. Semiconductor materials may be, for example, silicon, doped silicon, III-V semiconductors, GaAs and/or doped variants thereof such as InGaAsP, Lithium niobate. Dielectrics may be any of, but not limited to, polymers; silicon dioxide and/or doped variants thereof; silicon nitride and/or doped variation thereof; silicon oxynitride and/or doped variants thereof. The core material 6 typical has a refractive index at the desired mode wavelength operation that is higher than the surrounding cladding materials. The waveguide assembly 4, including the any of the heating elements, pillars 32 and contact electrodes 34 may be formed using any suitable materials processing technology and fabrication steps including but not limited to growth, deposition, polymer spinning, patterning, lift-off and etching.

The wavelength range of operation of the waveguide assembly 4, i.e. the wavelengths of the optical mode 22 may be any wavelength including, but not limited to any of: between 700-1625 nm. For telecommunications and other applications such as quantum information generation, processing and detection, this may be in any one or more of the following bands: the O-band (original band: 1260-1360 nm); the C-band (conventional band: 1530-1565 nm), the L-band (long-wavelength band: 1565-1625 nm); the S-band (short-wavelength band: 1460-1530 nm); the E-band (extended-wavelength band: 1360-1460 nm). Other wavelengths and wavelength ranges may be used such as above 1625 nm. For example, wavelengths of 2000 nm or above.

The optical source may be wavelength tuneable. The optical modes are, essentially, the allowed spatio-temporal degrees of freedom that energy can take in the waveguide structure. Those modes can be carrying an arbitrary amount of light intensity from vacuum and single photons up to the physical threshold of the material. The temporal modes allowed can be structured (pulsed) or homogeneous (CW). The source of light for the modes 22 in the core 6, can be a laser, a diode, a quantum dot, a thermal source or any other source of electromagnetic radiation.

As discussed elsewhere herein, recesses 26 or other structures may be formed on or in localised areas of the waveguide assembly 4 to accommodate the substance 10 in the first state 18. These structures may allow the substance to be in contact with the core material or be within a distance (of the core material) of any of (but not limited to): 0-500 nm, 0-1000 nm, 0-1500 nm, 0-2000 nm, 0-2500 nm, 0-3000 nm, 0-3500 nm, 0-4000 nm, under 5000 nm, under 6000 nm. The abovementioned distances may reflect the thickness of the cladding material above the core material 6 in the recessed 26 area.

The length of the recess 26 or other feature may be any length including but not limited to any of: 1-200 µm;100-2000 µm; 1-10 mm.

The local area 16 that the energy emitter 12 acts upon to change the state of the substance 10 may be any shape or size and may be defined in any particular way, including by particular waveguide assembly features such as recesses 26, troughs, and pools formed by deposited upstands on top of the top surface of a waveguide over-cladding layer.

The substance 10 may be any substance in principle and may be a plurality of substances. Preferably the substance has a very low chemical reactivity so that it does not erode the apparatus 2 or waveguide assembly 4. One preferred substance is a noble gas, i.e. any one or more of: helium (He), neon (Ne), argon (Ar), krypton (Kr), xenon (Xe), and the radioactive radon (Rn). Other substances may be used as well including nitrogen and carbon.

An example of equipment and steps to providing an environment using xenon as the substance is now described. Any of the features and configurations of this example may be used with any of the methods and apparatus described herein.

This example uses a cryostat as described elsewhere herein. A mass flow controller (MFC) may be connected to a xenon line pressurised to >1 atm to prevent any ingress of external air. The xenon used may be 99.999% pure. The lines between the xenon gas bottle that feed the xenon to the main chamber of the cryostat, should ideally be evacuated to < 1e-4 mBar before pressurisation. The flow of xenon may be directed using a multi-axial translation stage connected to a wobble stick. The xenon may enter the main chamber through a hole of diameter 2 mm. The hardware may be linked to software for controlling all the equipment simultaneously. This would allow for synchronisation between separate pieces of equipment and for real-time control and measurement of xenon’s effect on the waveguide assembly 4.

The amount of substance 10 in the first state of matter that is deposited onto the waveguide assembly 4 may vary. When the substance 10 deposits in a recess 26 or other defined structure on the waveguide assembly 4, the amount of the substance may be any thickness including any of: 1 nm-5000 nm, 1000 nm-5000 nm, 2000 nm-5000 nm, 3000 nm-5000 nm, 4000 nm-5000 nm, less than 5000 nm.

As the substance layer gets thicker (for example it may accumulate on the waveguide assembly 4 over time) the propagating mode will experience less and less change as the field distribution outside of the waveguide core 6 grows exponentially weaker with radial distance.

The environment 8 may be any environment including, for example room temperature. The environment type is normally linked to the type of substance used. For example, if water is used as the substance then room temperate environment may be used.

A non-limiting example of providing a cryogenic environment is now described as follows wherein any of the features and configurations of this example may be used with any of the methods and apparatus described herein. The waveguide assembly 4 may be located inside a continuous-flow cryogenic probe station and cooled using liquid helium for a temperature range of 300 K to 4.2 K. The waveguide assembly 4 may be kept at a temperature of 45 K to minimise the sublimation of xenon after deposition and to minimise the risk of contamination from other gases. The waveguide assembly may be placed or housed rigidly and securely on a sample stage within the cryostat chamber. When the sample stage temperature is 45 K or lower, and the chamber pressure is approximately 2e-6 mBar, the xenon in the chamber will reliably adhere on the surface of the waveguide assembly (for example on exposed waveguides), forming a further cladding portion of solid xenon. Above this temperature the xenon gradually sublimates as the vapour pressure of the xenon exceeds the pressure of the local environment. An example relationship between vapour pressure and temperature of different substances with respect to sublimation (solid-gas state transition) is shown in FIG. 4. The sublimation curves are for nitrogen 40, oxygen 42, xenon 44 and water 46. The region 48 indicates local temperatures where xenon deposition can take place with no risk of contamination from traces of other gases. The horizontal line 50 indicates the vessel pressure.

Plotting the vapour pressure curves of these prominent gases allows the deposition to be planned so that sublimation of xenon is at temperatures where contamination is much less likely. The presence of any water vapour in the chamber may present issues when using other substances such as xenon.

To reduce the presence of water, the vacuum chamber of the cryostat may be left evacuated (for extended periods of time) to purge the majority of the water. Furthermore, the temperature of the waveguide assembly may be kept at an elevated temperature during cool-down to restrict the condensation of water on the chamber walls. The waveguide assembly 4 (also referred to as the ‘sample’) may be left to thermalise at a particular temperature, for example, 45 kelvin with the radiation shields of the cryostat kept below 10 K, while injecting xenon slowly into the chamber in steps ranging from 3 ml/min to 15 ml/min.

In general, the method and apparatus may use one or more energy emitters 12 as described elsewhere herein. Examples of energy emitters include lasers, LEDs and heating elements are provided; however other types of energy emitters are permissible as well. The laser may be a fixed wavelength or a tuneable laser.

The laser used as the energy emitter may be referred to as the desorption laser. Preferably this laser has a wavelength that matches the absorption spectrum of the substance 10.

The substance 10 should ideally be transparent to the wavelength of light to be input in the core waveguide 6, propagating as optical mode 22, to minimise the impact on absorption on the mode 22.

The heating elements 30 described above are located upon or within the waveguide assembly 4, however in principle a separate heating assembly may be provided that is physically separate to the waveguide assembly 4 and configured to locally target heat towards particular areas of the waveguide assembly 4.

For heating elements 30 on or within the waveguide assembly 4, the elements 30 may be formed upon waveguide core material 6 and/or waveguide cladding material. The arrangement of the heating elements depends upon the waveguide geometry and the optical property of the mode that is requiring tuning.

For example, if multiple waveguides in the waveguide assembly 4 are carrying optical modes wherein a first of the waveguides requires tuning with respect to the others, then an appropriate local area 16 of the waveguide assembly 4, proximal to the first waveguide, may be adapted to allow for the substance 10 to be in the first state of matter 18 in a region that significantly interacts with the optical mode propagating in that waveguide. The one or more other waveguides may not have the same adaption. However, because of the extra adaption proximal to the first waveguide, the substance 10 in that local area changes to the second state of matter 20 which in turn affect the effective index just for the first waveguide.

Heating elements 30 may be arranged to heat equally both the first and further waveguides by substantially the same amount. This allows for the same thermo-optic effect (hence refractive index changes) to be applied to the core/cladding materials of the first and further waveguides. The resulting heating from the heating elements 30 thus changing the effective index of the mode in the first waveguide by a relative amount that is primarily provided by the evaporation of the substance rather than any other thermo-optic effect of other materials.

### Interferometer Example

This apparatus 2 may be used, for example, with an interferometer circuit on the waveguide assembly 4 with multiple arms and MMI (or other) optical splitters or combiners wherein one of the waveguide arms has a portion of the core waveguide 6 exposed to the local environment 8 (hence contactable by the substance 10). The heaters 30 may be disposed symmetrically about the multiple waveguides. For example, a first MMI is used to split the light into the two or more optical waveguide arms. If the waveguide arms are spiral shaped (they may have other waveguide circuit shapes) then the on-chip heaters may be located symmetrically in close proximity to the spirals so as to heat the waveguides, but induce no thermal phase shift between them.

Physical proximity of the heatering element 30 may be limited by the size and geometry of the recess 26 windows and also the shape and size of the heating element/s themselves. These heating elements 30 therefore serve to tune the thickness of the substance layer (for example xenon) covering the exposed waveguide.

The light from both paths are then recombined by another MMI to a single optical output waveguide.

The heating elements 30 may be provided with any suitable heating power, for example anywhere between 1 mW to 100 mW.

The optical sources used to launch the modes 22 of the waveguide assembly 4 may be any optical source, for example a laser. This laser may be passed through or may have a portion of its output diverted to an optical power/spectral monitor which provides readouts of laser wavelength and power. The laser light may also be passed through a polarisation controller to maximise light coupled into the PIC.

### Example Method for Controlling a Characteristic of an Optical Mode

There is further presented a method for controlling a characteristic of an optical mode supported by a waveguide core material 6 of a waveguide assembly 4. The method may use an apparatus 2 as described above and elsewhere in the present application, including, for example in any of the examples described for FIGS. 1a, 1b, 2a, 2b, 3a, 3b, 5. The method may be adapted with any feature or configuration or step described elsewhere herein, including any other steps from further example methods described herein.

The method comprises the following steps.
1) Providing a substance 10 in a first state of matter and in proximity to at least one control area of the waveguide assembly 4 proximal to the waveguide core material 6.
2) Controlling at least one energy emitter 12 to reversibly change between first and second emitter states of the energy emitter 12. The first emitter state for changing the state of matter of a portion, or the totality, of the substance 10, in proximity of the at least one control area, from the first state of matter to a second state of matter that is different to the first state of matter, wherein the second state of matter of the substance 10 in proximity to the at least one control area is associated with a first characteristic state of the optical mode. The second emitter state for changing the state of matter of a portion, or the totality, of the substance 10, in proximity of the at least one control area, from the second state of matter to the first state of matter. The first state of matter of the substance 10 in proximity to the at least one control area associated with a second characteristic state of the optical mode 22 that is different to the first characteristic state.

Prior to performing the steps 1) and 2) above, the method may locate the waveguide assembly 4 inside a temperature and/or pressure and/or volume-controlled environment 8. Optionally, the waveguide assembly 4 may also be optically and/or electrically connected to other components such as a source of light for propagating into the waveguide assembly and electrical connections to control different equipment including components of the apparatus 2. The temperature and/or volume and/or pressure-controlled environment may comprise a chamber.

After the waveguide assembly 4 is inserted into the environment 8, any one or more of the following steps may be used. The chamber may be pumped to a vacuum level after the waveguide assembly 4 is inserted into the chamber. The waveguide assembly 4 may be cooled, for example using a Thermo electric cooler or by being in an environment that has cryogenic elements. The optical (i.e.light intended for mode 22) and/or electrical connections to the waveguide assembly 4 may take place after the vacuum and cooling operations. Additionally, or alternatively, these connections may be refined or calibrated to achieve better electrical connection and/or optical alignment. Then the substance 10, such as xenon, may be introduced. The change of the optical properties of the mode of the waveguide assembly 4 may be monitored throughout the method changing the state of the substance 10. This may be done for all optical modes or components of the waveguide assembly 4 having local control areas. Optionally, the method may continue to provide or keep the substance in the first state in contact with the assembly (or allow it to keep adhering) until certain criteria are met. These criteria may be until a performance reaches and/or exceeds the desired set-point throughout, for any of the optical modes considered (which indicates the effect of the change in physical characteristics of the control areas). This may be done for all the different modes or control areas on the waveguide assembly 4 simultaneously. The parameters of the optical modes for any control areas may then be tuned, as described elsewhere herein, by utilising the energy emitter/s 12 associated with that structure. For example, there may be multiple structures about the waveguide assembly 4 including a recess 26 as shown in FIG. 3a and other structures of the waveguide assembly that are configured to utilise the refractive index tuning method described above.

For multiple control areas and/or multiple optical modes, this may be done simultaneously or serially. Any one or more of the previous steps may be repeated and the optical characteristics retuned (for example introducing more substance into the environment again and repeating the following steps). Once the target performance for the structures considered has been reached, the waveguide assembly 4 might be used for any other specific purpose, while the environment conditions are kept constant. If the performance of any structure within the waveguide assembly 4 deviates from the set-point, for example an interferometer having two arm recesses 26 similar to that of FIG. 3a, any one or more of the previous steps may be repeating again and the optical characteristics recovered. The environment conditions may be reverted to regular atmospheric parameters at any time to undo all the modifications. The waveguide assembly 4 may then be retrieved from the area of controlled environment.

The energy emitter 12 may be any feature, device of component that can controllably emit energy or controllably deliver energy (i.e. an energy deliverer) that causes the matter state change of the substance 10. For example, the energy emitter 12 can be any of, but not limited to, a heating element or a light source such as a laser. The emitter states are operational states, for example emitting energy or not emitting energy, or emitting a first level of energy or a second level of energy wherein one of the levels is larger than the other.

Characteristics of the optical mode 22 supported by the waveguide include any characteristics, including but not limited to any one or more of: the effective index of the mode 22, the absorption characteristics of the mode 22. Changing the cladding of a PIC alters the effective refractive index, and therefore the group index that the propagating mode 22 of light experiences, providing a means of phase control.

Deposition of Xe gas may be used in a cryogenic system as a mechanism to tune PICs. Xenon may be used for its low reactivity, high density and sublimation point. Xenon (Xe) has previously been used in a condensed state to increase the statistical likelihood of finding a semiconductor quantum dot (SQD). Such a method has been described in ‘Scanning a photonic crystal slab nanocavity by condensation of xenon’, by S. Mosor et. al., Applied Physics Letters 87, 141105 (2005). In this paper Xe or nitrogen gas was condensed onto a photonic crystal slab nanocavity held at 20 K. Allowing xenon or nitrogen gas to condense onto the photonic crystal slab nanocavity resulted in shifts of the nanocavity mode wavelength which was described by Mosor as being useful for cavity quantum electrodynamics experiments.

However, in the present application, the thickness of the cladding can be adjusted by locally heating the exposed waveguides, causing the xenon to sublimate until the required cladding thickness is reached. Once the heating process is stopped no additional power consumption is required and the circuit may remain stable whilst under cryogenic conditions.

The above method may further provide, in any order: a) adding and/or removing material from the waveguide assembly 4 to create one or more control areas of the waveguide assembly 4; b) providing a substance 10 in a first state of matter and in proximity of at least one of the control areas.

The method may further comprise removing material of the waveguide assembly 10 to form a structure within or proximal to the control area. The method may further comprise removing waveguide cladding material to create a recess 26 in a waveguide cladding layer.

The method may further comprise adding and/or removing material respectively to/from the waveguide assembly wherein the added and/or removed material forms at least a portion of any one or more of: the energy emitter 12; a structure for delivering energy from the energy emitter to the control area. By adding and/or removing material, structures may be formed on or within the waveguide assembly for delivering heat energy to the substance 10 in the local area of interest. Thus, the present application may provide for reconfiguring at least part of the geometry of the waveguide assembly 4.

The method may further comprise adding an element to the waveguide assembly 4, the element for heating the substance. The element may be an electrically conductive element such as an electrical heating element 30. The method may further provide that the energy emitter comprises a light source.

The waveguide assembly 4 may be within a temperature-controlled and/or pressure-controlled environment. The waveguide assembly 4 may be within a cryogenic environment. The substance may be any of: substantial non-chemically reactive; and optionally, a noble gas such as xenon.

The waveguide assembly 4 may comprise a plurality of control areas wherein the characteristics of the optical mode supported by the portion of the core material proximal the control areas are controlled independently. The control areas may be spatially separated from each other. The control areas may not overlap or may partially overlap, but may be controlled independently.

The method may further provide for inputting light into the waveguide core material 6. The method may further comprise sending a control signal to the energy emitter 12 to change its state from the first to the second emitter state or vice versa. The control signal may be any control signal including mechanical movement from a mechanical system, an electrical signal, an optical signal, an acoustic signal. The method may provide that the core material 6 forms at least part of any one or more of: an optical detector; an optical source; an optical waveguide circuit comprising a plurality of optical waveguides.

The method may provide that the first state of matter is a solid or a liquid. The method may provide that the second state of matter is a gas.

Any of the above discussed options, for this method, for configuring the apparatus, environment or waveguide assembly, may also be applied to other examples herein including those of FIGS. 2a, 2b, 3a, 3b, 5 and the method of the first aspect and the apparatus of the second aspect.

### Example Using Xenon in a Cryogenic Environment

There is now presented an example for tuning the characteristics of an integrated photonic circuit using Xenon in a cryogenic environment. The features of the following may be adapted according to features and configuration of other examples herein including any of the apparatus and methods described above.

Such a circuit routes light using the contrast of the refractive index between the index material and the environment (cladding or air). In a cryogenic environment (Temp. < 100 K), such as the required for Superconducting Nanowire Single Photon Detectors (Temp. < 4 K), the method and apparatus may provide for injecting a small amount of gas (such as Xe) that, at an environmental pressure below 10⁻⁶ mBar, will condensate on every exposed surface of the circuit. This layer of substance locally changes the optical properties of the photonic circuit, with the change depending on the thickness of the film deposited. This process is reversible with temperature; if the environment is kept at a pressure of 10⁻⁶ mBar and the temperature is increased above 70 K, the Xe will return to gas phase, reducing effectively the thickness of the film and recovering the original structure. If the temperature (and the pressure in the chamber) of the photonic circuit does not change, the film thickness will not change, effectively sustaining the change induced indefinitely.

The present application may locally change the temperature thus affecting only a single (or subset of) structures on the PIC. In this way, complex circuits can be tuned accurately and sustained with a much lower power budget than other conventional methods. The mechanisms for affecting the substance state change considered may be but are not limited to: local heaters and optical sources such as lasers emitting a laser beam directed to specific locations on the sample surface. The energy emitters 12 may also be energy delivering mechanisms wherein the mechanisms deliver energy to the substance 10. Other energy emitting mechanisms include acoustic transducers, wherein, for example the transducer is set to focus acoustic energy onto the substance.

These focussed or local mechanisms may be used in conjunction with global energy delivering mechanisms such as global heating mechanisms that affect the whole waveguide assembly 4.

The combination of superconducting single photon detectors with a reconfigurable photonic circuit has advantages in applications such as in quantum information processing (computing, simulation, communications, etc) as well as enhanced sensing for biology and astronomy applications.

Compared to alternative switching mechanisms, the methods and apparatus described herein may provide any of the following advantages: 1) Lower power dissipation than standard uses of thermal phase-shifters and plasma-based modulators; 2) Lower optical loss than plasma-based modulators, and all-optical modulators; 3) A more balanced (on/off) optical response than plasma-based modulators; 4) Compatibility with standard photonic fabrication protocols/technologies such as CMOS; 5) More stable and robust set-up than opto-mechanical and electro-opto-mechanical switches and modulators; 6) Lower cross-talk than electrically driven switches and modulators; 7) Smaller footprint than all-optical modulators; 8) Allows for a wire-less configuration (other switches and modulators may require on-chip electrical wires) 9) intrinsic compatibility with cryogenic operating environments.

The methods and apparatus presented herein may therefore allow for multiple photonic structures to be tuned at different rates/levels. The methods and apparatus presented herein may be applicable to a variety of integrated photonic structures and devices.

Any of the above discussed options, for this example of using Xenon in a cryogenic environment, for configuring the apparatus, environment or waveguide assembly, may also be applied to other examples herein including those of FIGS. 2a, 2b, 3a, 3b, 5 and the method of the first aspect and the apparatus of the second aspect.

### Example Method for Controlling and Tuning the Optical Properties of Photonic Structures

A further example of a method for controlling and tuning the optical properties of photonic structures is described as follows. The method is for controlling and tuning the optical properties of photonic structures in a cryogenic environment. This method may also include any combination of the features described below.

This method uses a photonic chip, containing waveguide structures made in high-refractive index material such as silicon or silicon nitride. The photonic structures may include but are not limited to: single waveguides, directional couplers, resonators, multi-mode interference regions, grating couplers.

The photonic structures may be protected/static structures which are completely encased in a passivation material such as silicon oxide.

Additionally, or alternatively the photonic structures may be exposed/dynamic structures which are completely or partially exposed to the environment 8. For the exposed/dynamic structures the waveguide core material 6 may not be covered by a passivating material. If it is, the thickness of said material may be below a few (^{~}20) nm.

This method uses a cryostat to host the photonic device. The cryostat should be able to reach a base temperature of at least 50 K or below, ideally 10 K or below. The cryostat may have features to interface with the photonic device, either electrically, optically or both electrically and optically. The cryostat may also have a vacuum pumping station capable of reaching a base pressure of ^{~}10⁻⁶ mBar.

This method uses a neutral gas injection system connected to the cryostat. The neutral gas is preferably non-reactive, with high refractive index in solid state and a condensation temperature (vapor pressure) above that of liquid Nitrogen, but below that of liquid He, such as Xenon. The gas may be contained in a pressurised (controlled) container, and connected to the cryostat via a calibrated mass-flow controller (MFC) capable of delivering flow rates below 5 ml/min. The connection in the cryostat delivers the gas in close proximity to the photonic circuit surface.

This method uses an electronic apparatus comprising an electronic control system to monitor (using appropriate sensors): the pressure of the chamber, the photonic circuit performance, the flow rate of neutral gas and the temperature(s) in the cryostat. The system may include laser sources, current/voltage sources, and DAC electronic systems. This cryostat may be used with other examples herein including any of FIGS. 2a, 2b, 3a, 3b, 5.

The example method steps are described in the following steps 1-10. It is envisaged that these method steps may be adapted according to any other step, feature or configuration described herein. Furthermore, other steps may be added, steps may be removed or placed in a different order. Furthermore, any of the steps features and configurations described in this method may be used in other examples of the method and apparatus described herein.
1.The system is set up. The photonic device (PIC) is placed inside the cryostat and connected electrically and/or optically to the electronic control system. The gas injection system is then aligned and connected, making sure there is not contamination nor gas leaks. Contamination may disturb the normal calibrated operation of the method.
2. The device chamber is isolated and pumped to a vacuum level of ^{~}10⁻⁴ mbar. [reducing the influence of (mainly) nitrogen and oxygen gas in the process].
3. The device temperature is brought down to the base temperature.
4. Optical and/or electrical connections are established, checked and aligned to optimise coupling parameters. This may be necessary for calibration of the process but may not be required for normal operation.
5. A small amount of Xe is injected in the chamber in the vicinity of the surface of sample. This can be done by controlling the MFC flow rate for a limited time. Example injection parameters: for a silicon photonics chip at 50 K with Xe gas is 1 ml/min for 1-2 seconds. Such parameters may produce measurable changes. The specific injection parameters are dependent on the geometry of the system.
6. The optical properties of the structures are monitored until the performance exceeds the desired set-point throughout all the different PIC structures. This can be done simultaneously or sequentially. In this example method, the set-point is exceeded because the next steps push the operational parameters back closer to the levels measured in step 4.
7. Individual exposed or partially exposed structures are addressed and tuned individually. This is done via electrical resistors (i.e. heating elements) and/or light from a light source external to the silicon device. Electrical resistors on-chip (such as those used for thermo-optic phase shifters) may induce a local temperature increase. The exact operational parameters vary between technologies and geometries. For example: silicon-based thermal phase-shifters may require a few mW of power (V-mA) for ^{~}1 s) to achieve measurable changes. An external light source (e.g. laser or high-power LED) is typically one capable of delivering sufficient power at an absorption region of the neutral gas (in solid state) without affecting the rest of the photonic circuit. The wavelength and intensity of light is defined by the specific substance, and material platform of the photonic circuit. Such light should be directed at specific spots on the surface of the sample corresponding with the exposed structures, or regions that are thermally connected to the desired structures.
8. If by effect of tuning one or several structures, others become miss-aligned, the method may return to point 5 the process repeated. Otherwise the method proceeds to normal operation of the device (PIC). Thermal-cross talk and the re-deposition of the sublimated/evaporated gas are the main reasons for this step. Therefore, this will be highly dependent on the circuit geometry and the amount of power applied locally.
9. If the PIC structures need re-tuning, the temperature of the photonic circuit is increased beyond that of the evaporation/sublimation of the neutral gas (For Xe ^{~}120 K at ^{~}10⁻⁵ mbar), the chamber is evacuated using the vacuum pumping system and the method proceeds again from step 2. It is also possible to increase the pressure by injecting more neutral gas to push the system to a more stable state, losing any previous adjustments.
10. If operation of the device is complete, the system (and photonic circuit) temperature is increased to room temperature while using the vacuum pumping system to keep the pressure below 10⁻³ mbar. After this step, a final check of the performance of the device, at room temperature, may be used to confirm no degradation.

Any of the above discussed options, for this method for controlling and tuning the optical properties of photonic structures, for configuring the apparatus, environment or waveguide assembly, may also be applied to other examples herein including those of FIGS. 2a, 2b, 3a, 3b, 5 and the method of the first aspect and the apparatus of the second aspect.

Any of the examples of methods and apparatus described herein can be used to combine, for example, high-performance single-photon detectors with a reconfigurable photonic circuit. This could include, but not be limited to, a device to spectrally analyse very weak optical signals such as biological samples. Larger optical power signals could cause damage, and signals might be otherwise to weak. Similarly, a single-photon spectral analyser could be used in astronomy applications. The tunability in each case would allow for different optical channels (frequencies) to be adjusted independently, maximising the system’s performance.

In a quantum computing application, the methods and apparatus could realise a photonic circuit that generates single photons, routes them and detects them on a photonic chip. Changing the configuration of the photonic circuit using the methods and apparatus described herein can be used to compute information. Such a circuit could have many switches compared to standard available commercial platforms. The methods and apparatus may thus allow increasing the complexity of a device, and hence the computing power. Furthermore, the method can be used to finely tune single photon sources without increasing the power budget of the system. The methods and apparatus described herein can be used to compensate for inaccuracies in a photonic circuit, resulting from a limited fabrication precision i.e. improving the performance of lower-quality photonic circuits._Many other applications that require a finely-tuned integrated photonic circuit may benefit from this methods and apparatus described herein if an appropriate substance is used. It is further envisaged that -room-temperature operation is possible in controlled environments.

Example of an apparatus, with a processor, for controlling a characteristic of an optical mode FIG. 5 shows an example of an apparatus associated with a third aspect. This apparatus may be used for any of the methods described elsewhere herein, for example the method of the first aspect or the example methods described above. In this example the apparatus is for controlling an optical mode propagating within an optical waveguide assembly 4. The optical waveguide assembly comprises at least a waveguide core material 6 for guiding the optical mode and being in an environment 8 comprising a substance 10. The apparatus comprises a processor (exemplified as an electronic controller). The processor is configured to transmit one or more control signals to at least one energy emitter 12. The energy emitter 12 is for reversibly changing (14) at least a portion of the substance 10 in contact with a portion of the waveguide assembly 4 in a localised area 16 of the waveguide assembly 4. The change is from a first state of matter 18 to a second different state of matter 20. The change of state of matter is for changing a characteristic of the optical mode 22. The processor is also configured to receive a sensor signal from a sensor monitoring the optical mode 22. This example may include features from other examples herein including, but not limited to, any one or more of: the type of environment or equipment to enable the environment; the type of optical sources used to input light into the waveguide assembly, the features of the waveguide assembly; the type of energy emitters; the types of substances and the methods used to operate the apparatus.

The processor may generate one or more further control signals based upon the received sensor signal and transmit the one or more further control signal to the said at least one energy emitter. In generating of the further signal, the processor may compare the sensor value to a reference value, for example a predetermined value stored in a memory that may indicate the threshold or target level of a property of the mode, for example, a particular polarisation or intensity. One or more control signals may be transmitted to a first energy emitter and/or a second energy emitter. The first energy emitter may be associated with a first localised area 16 of the waveguide assembly 4 whilst the second energy emitter may be associated with a second localised area 16 of the waveguide assembly 2. FIG. 5 shows the substance 10 being in solid form 18 and change 14 into gas form 20 upon activation of the heater 12.

In FIG. 5 the environment 8 is a cryogenic environment hosted by a cryogenic chamber 52. An electronic controller 54 comprises the processor which may automatically perform the tasks above or may be assisted by user-controlled actuators 56 that allow a user to turn on or off certain functions. A laser light source 28 is located outside the chamber and inputs light via an optical fibre into the chamber 52. The light from the light source 28 is input into the waveguide core 6 of the waveguide assembly 4. The light output from the waveguide assembly 4 is input via an optical fibre into an optical detector 58. The optical detector 58 is electronically coupled via a wired connection to the controller 54. The controller 54 also controls, for example by a wired connection, the cryogenic chamber output apparatus 60 which includes a valve. This output controls the pressure of the chamber 52. The controller 54 also controls, for example by a wired connection, the flow of Xe from a Xe reservoir 62 into a Xe input 64 of the chamber 52. This is done by actuating a valve 66 in the gas line linking the reservoir 62 to the input 64. In this example the energy emitter 12 is a heater that is electronically controlled by the controller 54 and works in a similar manner discussed in other examples above, for example in FIGS. 3a, 3b. As with other examples, further detectors, light sources, energy emitters may be used. Furthermore, the waveguide assembly may have more than one local area 16 where the substance 10 is to locate. Other features in the figure are represented with like numerals in other examples.

### Example of an Apparatus Used to Tune an MZI

The following is a non-limiting example of a waveguide assembly 4 being a Photonic Integrated circuit (PIC) that used the apparatus and method described herein. In this example, an integrated Mach-Zehnder Interferometer (MZI), formed as a chip on a SOI (Silicon On Insulator) platform, was tuned using apparatus 2, described above, to characterize the modulation capability of Xe. Any of the features and configurations presented in this example may be used in other examples herein including those of FIGS. 2a, 2b, 3a, 3b, 5 and the method of the first aspect and the apparatus of the second aspect.

A set of standard strip silicon waveguides were created wherein each waveguide had a 500 nm width and a 220 nm height. These dimensions allowed for operation within the telecommunications C-band and to support the fundamental TE optical mode. The MZI structure had two identical waveguide arms wherein each arm formed a spiral in the plane of the platform. The SOI platform used a 2 µm layer of SiO₂ buried oxide (BOX) and another 3 µm of SiO₂ cladding. Two metallic layers were deposited and patterned on top of the cladding to form electrical wires, pads and resistive heaters to be used for localized thermo-optic phase shifting over specific waveguide sections. The two metallic layers were an aluminium layer having thickness of 2 µm and a titanium nitride layer having a thickness of 120 nm. The SiO₂ cladding nominally covering the top of the core material was removed from one of the arms of the MZI using a Buffered Oxide Etch (BOE 7:1), exposing the top of the core waveguide material spiral section entirely, thus creating a recess for Xe to locate into.

Grating-couplers were formed as optical inputs and outputs to interface with the chip and were optimized for the quasi-TE mode and an angle of incidence of 11 degrees to avoid back reflections from second-order diffraction effects.

For the interferometer design, the input light, for propagating in an optical mode, was input into an input waveguide optically connected to a multi-mode interference structure (MMI), acting as balanced beam-splitter designed for a 50:50 splitting ratio to split the input light into the two spiral arms.

The waveguide arm sections of the MZI, in a spiral configuration, were each 1 mm in length. The MZI structure is completed with a second 50:50 splitting ratio, 2 × 2 port, MMI that received light from the two waveguide arms and coupled light out of the chip into two output waveguides that in turn were optically coupled to optical fibres through two additional grating couplers.

Heater elements were located symmetrically along each arm of the MZI to provide a local heat source. Both heater elements were connected electrically in parallel to minimize any phase-shift in the optical path induced by heat.

The chip (or ‘Device Under Test’ (DUT)) was placed inside a continuous-flow cryogenic probe station. Thermal contact with the probe station sample-stage was made using a high thermal conductivity varnish. The probe station was evacuated to 110 mBar using a pumping system, and then cooled using liquid helium. Intrinsic system cryo-pumping brought the internal pressure down to 1106 mBar. The sample stage temperature was stabilized by adjusting the helium flow rate and local heating using PID temperature controllers. The test was operated between the equilibrium vapor pressure of Xe and O₂ at chosen range of temperatures, reducing the likelihood of any external contamination while maintaining negligible sublimation rates of Xe. The Xe flow rate was controlled using a mass-flow controller (MFC) connected to a Xe line pressurized to >1 atm to prevent external contamination. The Xe used was 99.999% pure, and the lines between the Xe gas bottle and the main chamber were evacuated to 110 mBar before the first pressurization.

The Xe flow was directed using a bi-axial translation stage connected to a wobble stick, with the Xe entering the main chamber through a nozzle of diameter 2 mm.

The DUT was probed optically using a C-band tuneable CW laser source to create the light for the optical mode propagating in the waveguide, to collect full optical spectra (1510 nm - 1590 nm) from both optical fibre outputs of the DUT. The input light polarization was set using a strain-based polarization controller, maximizing light coupled into the PIC.

Once the vacuum chamber reached its base temperature light was coupled light into and out of the chip (hence to propagate as the optical mode through the interferometer) through the use of the on-chip input grating couplers. The balance of optical power between the two different optical outputs of the on-chip MZI were used as a means to observe the deposition and sublimation processes of the Xe in the recess.

The DUT temperature was kept at 50-43 K. Temperatures of 45-43 K were chosen for the longest measurements due to subtle sublimation observed at 50 K. Xe was injected into the cryogenic chamber in discrete steps, with a flow range between 3 ml/min and 15 ml/min. Flow rates and injection times were changed dynamically throughout the experiment as the Xe films saturated.

Once Xe had deposited on the spiral waveguide surface in the recess, the on-chip heating elements proximal to the recess were used to accurately control the local temperature and sublimate the Xe at a controlled rate. Xe sublimation was tested using two pre-programmed depositions, followed by controlled sublimation until no further change was observable. Multiple films were successively deposited and sublimated, for consistency. No noticeable changes were observed in different film deposition behaviour.

As described above, once Xe was deposited in the recess, the on-chip heaters were used to increase the temperature in the vicinity of the exposed waveguide section. The optical power output from the MZI was monitored to determine interference data obtained during deposition to characterize the sublimation of the Xe films.

Plotting the oscillation in optical power out of the chip allows the observation of accumulation of optical phase in the spiral arm with the recess.

FIGS. 6a-6c show various graphs showing the change in the optical outputs of the integrated MZI with Xe deposition and sublimation.

FIG. 6a shows graph 70 wherein Xe is gradually deposited in the recess over a period of time shown on the X-axis. The two optical outputs 76 and 74 are associated with the left-hand Y axis and the Xe flow rate 72 is associated with the right-hand Y axis. As soon as the Xe flow is increased from close to 0 ml/min to roughly 3 ml/min, Xe is deposited about the waveguide assembly (which in this case is the PIC with the integrated MZI). As the recess is filled with increasingly more solid Xe, in a similar manner to FIGS. 3a/3b, the optical mode travelling down the MZI arm with the recess experiences different effective indices, hence different optical phase differences compared to the optical mode travelling in the other arm. This results in the typical interferometric cycling of opposing peaks and troughs between the two optical output arms wherein FIG. 6a shows a total 4π phase shift between the start and end of the Xe flow at 3 ml/min. In total 0.3 ml of Xe was introduced into the chamber at a rate of 3 ml=min. The total cumulative Xe volume in the vessel before this measurement was 1.5 ml at a temperature of 45 K.

FIG. 6b shows a similar graph 78 to that of FIG. 6a wherein Xe was deposited at 3 ml/min over a longer period so that 1.45 ml of Xe is introduced into the chamber at 4 K. Again, the two optical outputs 82, 84 (associated with the left-hand optical output power Y axis) are shown to start oscillating when the Xe flow 80 increased from around 0 to around 3 ml/min. The Xe thickness before this deposition was estimated to be 30 nm at a temperature of 4 K. The increasing thickness here equated to around 9π phase changes in the recess arm. FIG. 6c shows a graph 86 wherein an existing Xe deposition in the recess is then sublimated, at a surrounding temperature of 43 K, by driving electric current through the heating element in a similar way as shown and described for FIGS. 3a/3b. The respective powers of optical outputs 90, 92 are shown to oscillate through 2π phase shifts as the sublimation 88 starts. The sublimation occurred by applying 37 mW of electrical power for 10 s to the on-chip heater proximate to the recess (i.e., a heater similar to the heating element 30 in FIGS. 3a/3b).

1. A method for controlling a characteristic of an optical mode supported by a waveguide core material of a waveguide assembly;
the method comprising:
providing a substance in a first state of matter and in proximity to at least one control area of the waveguide assembly proximal to the waveguide core material;
controlling at least one energy emitter to reversibly change between first and second emitter states;
the first emitter state for changing the state of matter of a portion, or the totality, of the substance, in proximity of the at least one control area, from the first state of matter to a second state of matter that is different to the first state of matter,
wherein the second state of matter of the substance in proximity to the at least one control area is associated with a first characteristic state of the optical mode;
the second emitter state for changing the state of matter of a portion, or the totality, of the substance, in proximity of the at least one control area, from the second state of matter to the first state of matter;
the first state of matter of the substance in proximity to the at least one control area associated with a second characteristic state of the optical mode that is different to the first characteristic state.

2. The method of claim 1 wherein the waveguide assembly comprises a plurality of control areas:
wherein the characteristics of the optical mode supported by the portion of the core material proximal the control areas are controlled independently.

3. The method of claim 1, further providing, in any order
adding and/or removing material from the waveguide assembly to create one or more control areas of the waveguide assembly;
providing a substance in a first state of matter and in proximity of at least one of the control areas.

4. The method of claim 1, further comprising removing material of the waveguide assembly to form a structure within or proximal to the control area.

5. The method of claim 4 further comprising removing waveguide cladding material to create a recess in a waveguide cladding layer.

6. The method of claim 1 further comprising adding and/or removing material respectively to/from the waveguide assembly, the added and/or removed material forming at least a portion of any one or more of:
the energy emitter;
a structure for delivering energy from the energy emitter to the control area.

7. The method of claim 1 further comprising adding an element to the waveguide assembly, the element for heating the substance.

8. The method of claim 1 wherein the waveguide assembly is within a temperature-controlled and/or pressure-controlled environment.

9. (canceled)

10. The method of claim 1 wherein the substance is any of:
substantial non-chemically reactive; and optionally,
comprises a noble gas.

11. The method as claimed in claim 10 wherein the substance comprises xenon.

12-15. (canceled)

16. An apparatus for controlling an optical mode propagating within an optical waveguide assembly; the optical waveguide assembly comprising at least a waveguide core material for guiding the optical mode and being in an environment comprising a substance,
the apparatus comprising a processor configured to:
transmit one or more control signals to at least one energy emitter to reversibly change at least a portion of the substance in contact with a portion of the waveguide assembly in a localised area of the waveguide assembly, from a first state of matter to a second different state of matter; the change of state of matter changing a characteristic of the optical mode;
receive a sensor signal from a sensor monitoring the optical mode.

17. The apparatus of claim 16 wherein the processor:
generates one or more further control signals based upon the received sensor signal;
transmits the one or more further control signal to the said at least one energy emitter.

18. (canceled)

19. The apparatus of claim 16 wherein transmitting one or more control signals comprises:
transmitting a first control signal to a first energy emitter;
transmitting a second control signal to a second energy emitter.

20. The apparatus of claim 19 wherein the:
first energy emitter is for reversibly changing at least a portion of the substance in contact with a portion of the waveguide assembly in a first localised area of the waveguide assembly;
second energy emitter is for reversibly changing at least a portion of the substance in contact with a portion of the waveguide assembly in a second localised area of the waveguide assembly.

21-22. (canceled)

23. An apparatus of claim 16 wherein at least one of the energy emitters comprises a light source.

24. An apparatus for controlling an optical mode propagating within an optical waveguide assembly; the optical waveguide assembly comprising at least a waveguide core material for guiding the optical mode and being in an environment comprising a substance;
the apparatus comprising at least one energy emitter to reversibly change at least a portion of the substance in contact with a portion of the waveguide assembly in a localised area of the waveguide assembly, from a first state of matter to a second different state of matter; the change of state of matter changing a characteristic of the optical mode.

25. (canceled)

26. The apparatus of claim 24, wherein at least one of the energy emitters comprises a heater.

27. The apparatus of claim 26 wherein the heater is integral to the waveguide assembly.

28. The apparatus of claim 24 wherein at least one of the energy emitters comprises a light source.

29. The apparatus of claim 24 wherein the waveguide assembly is located within a temperature and/or pressure-controlled environment.

30-32. (canceled)
